(19) United States
(12) Patent Application Publication
(10) Pub. No.: US 2011/0217481 A1
(43) Pub. Date: Sep. 8, 2011

(54) ELECTROMAGNETIC STRIP STABILIZER

(75) Inventors: Hisanori OHARA, Toyohashi-shi (JP); Kazuhisa MATSUDA, Toyohashi-shi (JP)

(73) Assignee: SINFONIA TECHNOLOGY CO., LTD., Minato-ku (JP)

(21) Appl. No.: 13/110,477

(22) Filed: May 18, 2011

Related U.S. Application Data
(63) Continuation of application No. PCT/JP09/69701, filed on Nov. 20, 2009.

(30) Foreign Application Priority Data
Nov. 21, 2008 (JP) 2008-298814

(51) Int. Cl. B05D 3/00; B05C 11/00

(52) U.S. Cl. 427/547; 118/672

(57) ABSTRACT

An electromagnetic strip stabilizer includes: a pair of electromagnets, opposed to each other, that generate magnetic forces to act on a steel strip passing between the electromagnets after a surface coating process being applied to the steel strip; a pair of sensors, each sensor provided for each of the electromagnets, that detect a distance between a corresponding one of the electromagnets and the steel strip; and a control section configured to control a current supplied to each of the electromagnets and control a vibration of the steel strip at least based on the distance between the steel strip and each of the electromagnets detected by each of the sensors. The control section determines control gains used to control the current supplied to each of the electromagnets at least based on a thickness and a width of the steel strip.

### CROSS REFERENCES TO RELATED APPLICATIONS

This application is a continuation application of International Application No. PCT/JP2009/069701, filed Nov. 20, 2009, the entire contents of which are incorporated herein by reference. PCT/JP2009/069701 claims priority to JP 2008-298814, filed Nov. 21, 2008.

### BACKGROUND OF THE INVENTION

1. Field of the Invention

The present invention relates to an electromagnetic strip stabilizer for use, for example, in facilities such as hot-dip-galvanized steel sheet manufacturing facility.

2. Description of Background Art

It has been commonplace to blow excess molten zinc off a steel sheet, that travels while being pulled up after having been passed through a molten zinc bath, by delivering a jet of compressed air or gas with an air knife section (e.g., that which includes a nozzle), for example, in a continuous hot-dip galvanizing line so as to provide a desired hot-dip galvanizing thickness. In such a case, if a steel sheet vibrates in such a direction as to approach or distance itself from the air knife section, the distance between the nozzle and steel sheet changes. This changes the pressure (jet force) to which the steel sheet is subject, thus leading to an uneven hot-dip galvanizing thickness and resulting in degraded quality.

For this reason, vibration stabilizers have been under consideration, each of which includes a pair of electromagnets and sensors, one provided on each of the electromagnets (refer, for example, to Patent Documents 1 and 2). The electromagnets are arranged opposed to each other to sandwich a travelling steel sheet. Each of the sensors detects the position of the electromagnet relative to the steel sheet (distance to the steel sheet). The current flowing into each of the electromagnets is controlled based on the position relative to the steel sheet (distance to the steel sheet) detected by the sensors, thus controlling the attractive forces of the electromagnets and providing reduced vibration of the travelling steel sheet.

### Prior Art Documents

Patent Documents

Patent Document 1: Japanese Patent Laid-Open No. Hei 10-60614 (Also issued as U.S. Pat. No. 6,471,153 the entire contents of which are incorporated herein by reference.)

Patent Document 2: Japanese Patent Laid-Open No. 2000-334512

### DISCLOSURE OF INVENTION

### Technical Problem

Incidentally, conventional vibration stabilizers determine control gains based only on the steel sheet thickness. The control gains are used to control the current flowing into the electromagnets. Such vibration stabilizers exercise control so as to maintain the unit tension (tension acting on a unit area (=tension acting on the steel sheet/sectional area of the steel sheet)) acting on the travelling steel sheet constant, taking only the steel sheet thickness into account. That is, a plurality of steel sheet thicknesses are, for example, estimated so as to properly stabilize the vibration of a steel sheet of varying thicknesses. Then, a plurality of gain tables, each having control gains associated with each thickness, are stored in a control section. The control gains are determined according to the thickness of the travelling steel sheet, thus exercising control so as to maintain the unit tension constant.

Depending on the line to which the control device is introduced, however, it is likely that the tension acting on the steel sheet that travels while being pulled up almost vertically may be maintained constant rather than the unit tension. In a case where the tension is maintained constant in a line as described above, for example, if the steel sheet thickness changes, the unit tension acting on the steel sheet will naturally also change. This may make it impossible to stably stabilize the vibration of the steel sheet, resulting in difficulty in proper control.

In the first place, whether the unit tension or the tension is maintained constant, if the control gains are determined based only on the steel sheet thickness, it is impossible to flexibly respond to the change in information about the steel sheet other than its thickness such as its width because the unit tension changes with change in thickness, resulting in difficulty in proper control. The fact that proper control is difficult to achieve translates into uneven hot-dip galvanizing thickness and degraded quality of hot-dip galvanized steel sheet as a result of failure to properly stabilize the vibration of a travelling steel sheet.

The present invention has been made in light of the foregoing, and it is a main aim of the present invention to provide an electromagnetic strip stabilizer capable of handling steel sheets whose information other than the thickness is different so as to properly stabilize the vibration of a travelling steel sheet.

### Technical Solution

That is, an electromagnetic strip stabilizer of the present invention includes electromagnets, sensors and a control section. The electromagnets are arranged opposed to each other. The sensors are provided one on each of the electromagnets to detect the distance from each of the electromagnets to the steel sheet travelling between the opposed electromagnets. The control section controls the current flowing into each of the electromagnets at least based on the distance between the steel sheet and each of the electromagnets detected by each of the sensors. The electromagnetic strip stabilizer is intended to stabilize and control, between the electromagnets, the vibration of a steel sheet passing between the electromagnets after a surface coating process and is characterized in that the control gains used to control the current flowing into each of the electromagnets are determined at least based on the thickness and width of the steel sheet. It should be noted that the posture of the steel sheet passing between the electromagnets is not specifically limited, and it is only necessary to select one of the vertical, horizontal and tilting postures as appropriate.

The electromagnetic strip stabilizer configured as described above can subdivide the control gains by adopting the width of the travelling steel sheet (sheet width) in addition to the thickness thereof (sheet thickness) as factors used to determine the control gains. As a result, when associated control gains are specified, the electromagnetic strip stabilizer can properly control the current flowing into each of the electromagnets for a steel sheet with not only a different thickness but also a different width. Therefore, if disposed in a surface coating process line (e.g., continuous hot-dip galvanizing line or surface painting line) together with an air knife section adapted to blow excess molten zinc off a steel sheet, the electromagnetic strip stabilizer can effectively stabilize the vibration of a travelling steel sheet with a different thickness and width using subdivided control gains. This makes it possible to maintain the distance between the steel sheet and air knife section within a constant range, thus preventing the variation in jet force acting on the steel sheet and providing a uniform or almost uniform thickness of the coating formed by the surface coating process. Further, the electromagnetic strip stabilizer of the present invention allows for hot dipping to be used as a surface coating process. Hot dipping is conducted by passing a steel sheet through a bath of molten metal. Still further, the electromagnetic strip stabilizer of the present invention may stabilize the vibration of a steel sheet passing between the electromagnets while being pulled down after the surface coating process or a steel sheet passing between the electromagnets while travelling horizontally after the surface coating process. However, it is preferred that the electromagnetic strip stabilizer should stabilize the vibration of a steel sheet passing between the electromagnets while being pulled up after the surface coating process.

Further, if the electromagnetic strip stabilizer determines the control gains based not only on the sheet thickness and width but also on the steel sheet type (type of steel), the control gains can be subdivided more than in conventional vibration stabilizers, thus making it possible to stabilize the vibration of a travelling steel sheet made of a different type of steel.

### ADVANTAGEOUS EFFECTS

The present invention properly stabilizes the vibration of a travelling steel sheet whose information other than the thickness, and more specifically, sheet width and steel type are different, thus preventing uneven thickness of the coating formed by the surface coating process.

### BRIEF DESCRIPTION OF DRAWINGS

[FIG. 1]

FIG. 1 is a diagram schematically illustrating the configuration of an electromagnetic strip stabilizer according to an embodiment of the present invention.

[FIG. 2]

FIG. 2 is diagrams schematically illustrating the outline of table management in a programmable controller in the same embodiment and the content of gain tables.

### DETAILED DESCRIPTION OF THE INVENTION

A description will be given below of an embodiment of the present invention with reference to the accompanying drawings.

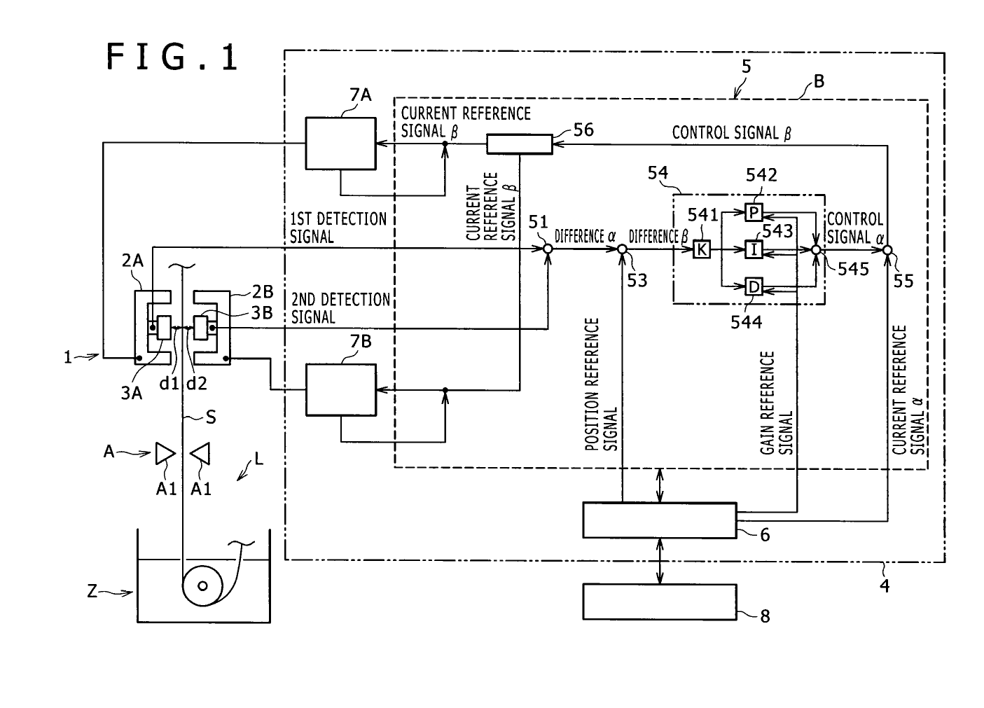

An electromagnetic strip stabilizer 1 according to the present embodiment is disposed downstream of a bath of molten metal (molten zinc bath Z in the present embodiment), for example, in a continuous steel sheet plating line L as illustrated in FIG. 1 to stabilize the vibration of a steel sheet S that travels while being pulled up after having been passed through the molten zinc bath Z. It should be noted that FIG. 1 schematically illustrates the steel sheet S as seen from the side. Further, in the continuous steel sheet plating line L (steel sheet plating line using molten zinc in particular is referred to as a “Continuous Galvanizing Line (CGL)”), an air knife section A having nozzles A1 with injection ports directed toward the steel sheet S is provided between the molten zinc bath Z and electromagnetic strip stabilizer 1 to blow excess molten zinc off the steel sheet S that travels while being pulled up after having been passed through the molten zinc bath Z by delivering a jet of compressed air or gas onto the steel sheet S from the injection ports of the nozzles A1. Known bath and knife section A can be used respectively as the molten zinc bath Z and air knife section A. Therefore, the detailed description thereof is omitted.

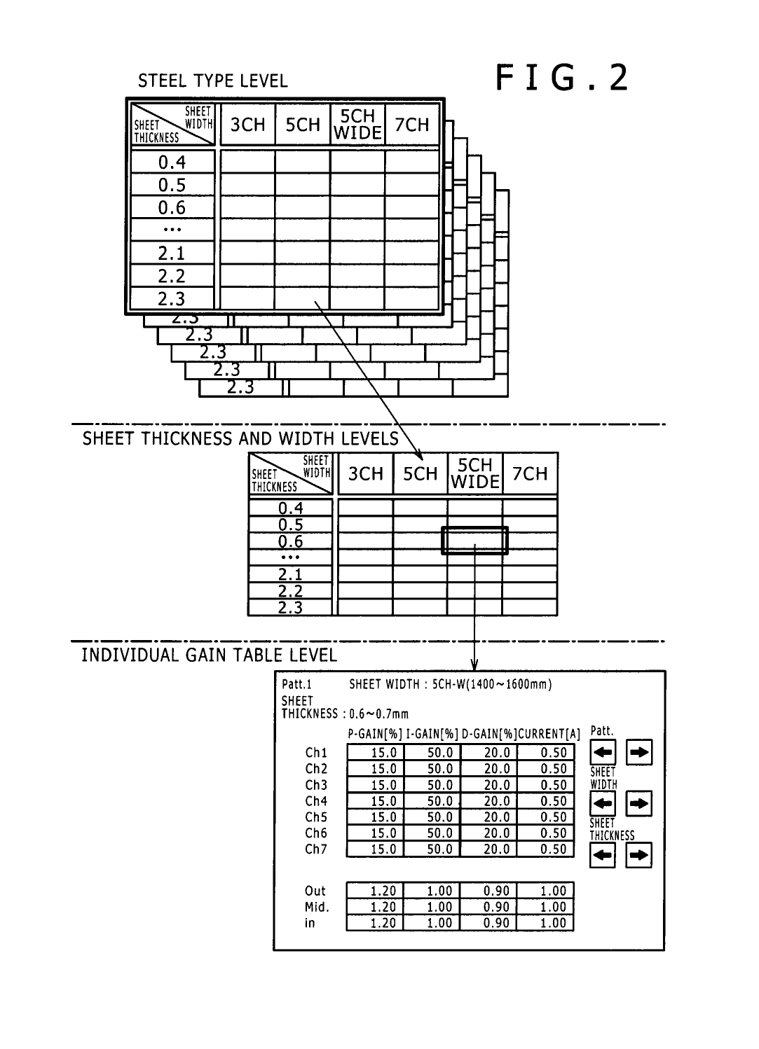

As illustrated in FIGS. 1 and 2, the electromagnetic strip stabilizer 1 includes first and second electromagnets 2A and 2B, first and second sensors 3A and 3B and a control section 4. The first and second electromagnets 2A and 2B are arranged opposed to each other so as to be able to sandwich the steel sheet S in the thickness direction. The first and second sensors 3A and 3B are each provided on the surface of one of the electromagnets (first and second electromagnets 2A and 2B) opposed to the steel sheet S to detect the distance to the steel sheet S. The control section 4 controls the current flowing into each of the electromagnets (first and second electromagnets 2A and 2B) at least based on the distance between the steel sheet S and each of the electromagnets (first and second electromagnets 2A and 2B) detected by each of the sensors (first and second sensors 3A and 3B).

A known type of electromagnet is used as each of the first and second electromagnets 2A and 2B. A concave portion is formed on the pole surface, i.e., the surface opposed to the steel sheet S, of each of the first and second electromagnets 2A and 2B. The first and second sensors 3A and 3B are provided respectively in the concave portions of the first and second electromagnets 2A and 2B.

The detection surface of each of the first and second sensors 3A and 3B is flush or almost flush with the pole surfaces of the associated electromagnet (first or second electromagnet 2A or 2B). The first and second sensors 3A and 3B are opposed to each other with the steel sheet S sandwiched therebetween. The first and second sensors 3A and 3B detect distances d1 and d2 to the steel sheet S, respectively, and output their detection results (first and second detection signals) to the control section 4.

The control section 4 includes a controller 5, programmable logic controller 6 and first and second amplifiers 7A and 7B. The controller 5 receives the outputs from the sensors (first and second sensors 3A and 3B). The programmable logic controller 6 outputs at least an instruction (gain reference signal) relating to the control gains to the controller 5. The first and second amplifiers 7A and 7B supply currents respectively to the first and second electromagnets 2A and 2B based on an instruction (current reference signal β) relating to the current flowing into the first and second electromagnets 2A and 2B output from the controller 5.

The controller 5 includes first and second difference detection means 51 and 53, a PID control means 54, main addition means 55 and current control means 56. The first difference detection means 51 calculates the difference between the first detection signal output from the first sensor 3A and the second detection signal output from the second sensor 3B. The second difference detection means 53 calculates the difference between a difference α output from the first difference detection means 51 and an instruction (position reference signal) relating to the appropriate control target position of the travelling steel sheet S output from the programmable logic controller 6. The PID control means 54 receives a difference β from the second difference detection means 53. The main addition means 55 adds together a control signal α, output from PID control means 54 according to the difference β fed from the second difference detection means 53, and a current reference signal α output from the programmable logic controller 6. The current control means 56 outputs, to the first and second amplifiers 7A and 7B, an instruction (current reference signal β) relating to the current flowing into the first and second electromagnets 2A and 2B according to the sum (control signal β) output from the main addition means 55. It should be noted that a position instruction means (not shown) may be provided separately from the programmable logic controller 6 to output an instruction (position reference signal) relating to the appropriate control target position of the travelling steel sheet S. In this case, the second difference detection means 53 calculates the difference between the position reference signal output from the position instruction means and the difference α output from the first difference detection means 51.

The PID control means 54 includes a gain determination means 541, proportional control means 542, integral control means 543, derivative control means 544 and PID control addition means 545 as illustrated in FIG. 2. The gain determination means 541 receives the difference β from the second difference detection means 53. The proportional control means 542, integral control means 543 and derivative control means 544 control the current flowing into the first and second electromagnets 2A and 2B based on the output from the gain determination means 541 and that (gain reference signal) from the programmable logic controller 6. The PID control addition means 545 receives the outputs from the proportional control means 542, integral control means 543 and derivative control means 544. The control signal α output from the PID control addition means 545 is fed to the main addition means 55.

In the present embodiment, of the components of the controller 5, the first and second difference detection means 51 and 53, PID control means 54, main addition means 55 and current control means 56 are disposed on a control circuit board B. It should be noted that these means disposed on the control circuit board B, i.e., the controller 5, may be considered as making up the “control section 4” of the present invention. In this case, it can be said that the electromagnetic strip stabilizer 1 of the present invention includes the electromagnets (first and second electromagnets 2A and 2B), sensors (first and second sensors 3A and 3B), controller 5 (corresponds to the “control section” of the present invention), programmable logic controller 6 and amplifiers (first and second amplifiers 7A and 7B).

The programmable logic controller 6 stores, in the form of a table, control gains that are set for each combination of parameters (control parameters) as illustrated in FIG. 2. The parameters are the thickness (sheet thickness), width (sheet width) and type (type of steel) of the steel sheet S. That is, the programmable logic controller 6 stores a plurality of gain tables, each having appropriate gains associated with each combination of the parameters (sheet thickness, sheet width and steel type) as illustrated in FIG. 2. A gain table suitable for the travelling steel sheet S is selected from among the plurality of gain tables stored in the programmable logic controller 6. The control gains adapted to control the current flowing into the electromagnets (first and second electromagnets 2A and 2B) are determined (set) based on the selected gain table. In the present embodiment, for example, six steel types, 15 sheet thicknesses and four sheet widths are set. A total of 360 gain tables, each having a combination of a steel type, sheet thickness and sheet width associated with suitable control gains (P, I and D gains and currents), are managed (matrix-managed) for use in controlling the current flowing into the electromagnets (first and second electromagnets 2A and 2B). It should be noted that the number of steel types, sheet thicknesses and sheet widths may be increased or decreased as appropriate. The number of gain tables will increase or decrease according to the change in numbers of these parameters.

Further, in the present embodiment, thanks to an interface 8 provided between a line information management computer (not shown) managing line information, i.e., a device separate from the electromagnetic strip stabilizer 1, and the programmable logic controller 6, information about the line L, i.e., the sheet thickness, sheet width, steel type, tension and other information relating to the travelling steel sheet S, can be entered into the programmable logic controller 6. It should be noted that the information about the line L entered into the interface 8 can be displayed on an unshown touch panel or control panel.

A description will be given next of how to use the electromagnetic strip stabilizer 1 and its function.

First, the person in charge of operation directly or the operation management computer (this operation management computer may also serve as the above line information management computer or be separate therefrom) automatically enters the sheet thickness, sheet width and steel type of the travelling steel sheet S via the interface 8. This transmits the sheet thickness, sheet width and steel type of the travelling steel sheet S to the control section 4. The control gains adapted to control each of the electromagnets (first and second electromagnets 2A and 2B) are set according to the sheet thickness, sheet width and steel type of the steel sheet S. As described above, the control gains are determined based on one of the gain tables stored (contained) in the programmable logic controller 6 according to the sheet thickness, sheet width and steel type of the steel sheet S. The determined control gains are fed to the controller 5 (more specifically, PID control means 54) as an instruction (gain reference signal) relating to the control gains.

Then, as illustrated in FIG. 1, each of the first and second sensors 3A and 3B detects the distance to the steel sheet S that travels between the first and second electromagnets 2A and 2B while being pulled up after having been passed through the molten zinc bath Z, outputting its detection result (first or second detection signal) to the controller 5. The controller 5 outputs, to the first and second amplifiers 7A and 7B, an instruction (current reference signal β) relating to the current flowing into the first and second electromagnets 2A and 2B based on these pieces of detection information (first and second detection signals), and gain reference signal output from the programmable logic controller 6.

More specifically, the first and second detection signals detected respectively by the first and second sensors 3A and 3B are fed to the first difference detection means 51. The first difference detection means 51 calculates the difference between the first and second detection signals. The calculated value (difference α) and the position reference signal output from the programmable logic controller 6 (or a position instruction means provided separately from the programmable logic controller 6) are fed to the second difference detection means 53. The second difference detection means 53 calculates the difference between the calculated value (difference α) and position reference signal. The difference β calculated by the second difference detection means 53 is fed to the PID control means 54. The gain reference signal from the programmable logic controller 6 is also fed to the PID control means 54. More specifically, the difference β calculated by the second difference detection means 53 is fed to the gain determination means 541 of the PID control means 54. The output from the gain determination means and the gain reference signal output from the programmable logic controller 6 are fed to the proportional control means 542, integral control means 543 and derivative control means 544. The outputs from the proportional control means 542, integral control means 543 and derivative control means 544 are fed to the PID control addition means 545. The PID control addition means 545 adds together the outputs from the proportional control means 542, integral control means 543 and derivative control means 544. The control signal α based on the sum thereof is fed to the main addition means 55. The main addition means 55 adds together the control signal α output from the PID control addition means 545 and the current reference signal α output from the programmable logic controller 6. The control signal β based on the sum thereof is fed to the current control means 56. The current control means 56 outputs, to each of the amplifiers (first and second amplifiers 7A and 7B), a signal (current reference signal β) relating to the current flowing into each of the electromagnets (first and second electromagnets 2A and 2B) based on the control signal β.

The current reference signal β output from the controller 5 after undergoing the above steps is fed to the first and second amplifiers 7A and 7B. Then, the current based on the current reference signal β is output from the first and second amplifiers 7A and 7B respectively to the first and second electromagnets 2A and 2B. The current flowing into the first and second electromagnets 2A and 2B is controlled as described above. As a result, the steel sheet S is positioned at the intermediate position between the first and second electromagnets 2A and 2B thanks to the attractive force of each of the electromagnets (first and second electromagnets 2A and 2B), thus stabilizing the vibration during travel.

This makes it possible to maintain, within a constant range, the distance between the steel sheet S that travels while being pulled up after having been passed through the molten zinc bath Z and each of the injection ports of the nozzles A1 making up the air knife section A, thus preventing the variation in jet force acting on the steel sheet S and providing a uniform or almost uniform galvanizing thickness.

Further, the electromagnetic strip stabilizer 1 has gain tables that use the sheet thickness, sheet width and steel type of the steel sheet S as control parameters as described above. Therefore, entering the sheet thickness, sheet width and steel type of the steel sheet S into the control section 4 makes it possible to control the current flowing into each of the electromagnets (first and second electromagnets 2A and 2B) based on the control gains recorded in the appropriate gain table after undergoing the above steps. Thus, the electromagnetic strip stabilizer 1 according to the present embodiment uses subdivided control gains for the steel sheet S with a different sheet width and steel type, thus permitting more flexible response than when the tension and unit tension acting on the travelling steel sheet are controlled by determining the control gains based only on the sheet thickness as has been done heretofore. This effectively stabilizes the vibration of the travelling steel sheet S, thus making the electromagnetic strip stabilizer 1 highly useful.

It should be noted that the present invention is not limited to the above embodiment. For example, the control gains used to control the current flowing into the electromagnets may be determined based only on the thickness of the steel sheet (sheet thickness) and width thereof (sheet width). Alternatively, the control gains may be determined based on the travelling speed or shape of the steel sheet.

Further, although a molten zinc bath is used as an example of a molten metal bath in the present embodiment, a bath containing molten tin, aluminum or resin material may be used instead. Still further, surface coating may be performed by spraying an appropriate surface treatment material onto the steel sheet. Still further, surface painting, for example, may be used as surface coating rather than hot dipping. Still further, the electromagnetic strip stabilizer of the present invention may stabilize the vibration of a steel sheet passing between the electromagnets while being pulled down after the surface coating process or a steel sheet passing between the electromagnets while travelling horizontally after the surface coating process. Still further, although a case has been described in the present embodiment in which the steel sheet passing between the electromagnets is in a vertical posture, the steel sheet may be in other posture such as a horizontal or tilting posture in the present invention when passing between the electromagnets.

In addition to the above, the specific configuration of each of the sections is not limited to that of the above embodiment, but may be modified in various manners without departing from the spirit of the present invention. Numerous modifications and variations of the present invention are possible in light of the above teachings. It is therefore to be understood that within the scope of the appended claims, the invention may be practiced otherwise than as specifically described herein.

### Industrial Applicability

The present invention properly stabilizes the vibration of a travelling steel sheet whose information other than the thickness, and more specifically, sheet width and steel type are different, thus preventing uneven thickness of the coating formed by the surface coating process and making the present invention applicable, for example, to a hot-dip-galvanized steel sheet manufacturing facility.
2: 2^{nd} detection signal
3: Current reference signal β
4: Difference α
5: Control signal β
6: Position reference signal
7: Gain reference signal
8: Steel type level
9: Sheet thickness
10: Sheet width
11: Sheet thickness and width levels
12: Individual gain table level

1. An electromagnetic strip stabilizer comprising:
a pair of electromagnets, opposed to each other, that generate magnetic forces to act on a steel strip passing between the electromagnets after a surface coating process being applied to the steel strip;
a pair of sensors, each sensor provided for each of the electromagnets, that detect a distance between a corresponding one of the electromagnets and the steel strip; and
a control section configured to control a current supplied to each of the electromagnets and control a vibration of the steel strip at least based on the distance between the steel strip and each of the electromagnets detected by each of the sensors, wherein
the control section determines control gains used to control the current supplied to each of the electromagnets at least based on a thickness and a width of the steel strip.

2. The electromagnetic strip stabilizer according to claim 1, wherein
the surface coating process is hot dipping conducted by passing the steel strip through a bath of molten metal.

3. The electromagnetic strip stabilizer according to claim 1, wherein the steel strip passes upward substantially in a vertical direction between the electromagnets.

4. The electromagnetic strip stabilizer according to claim 2, wherein the steel strip passes upward between the electromagnets.

5. The electromagnetic strip stabilizer according to claim 1, wherein the control section determines the control gains further based on a type of the steel strip.

6. The electromagnetic strip stabilizer according to claim 1, wherein each of the pair of electromagnets includes a series of the electromagnets arranged in a direction substantially perpendicular to a passing direction of the steel strip.

7. The electromagnetic strip stabilizer according to claim 6, wherein the control section further controls a transversal bend of the steel strip in addition to the vibration thereof.

8. The electromagnetic strip stabilizer according to claim 1, further comprising:
a gain memory configured to store data of appropriate gains each corresponding to each of different combinations of the thickness and the width of the steel strip, wherein the control section determines the control gains by referring to the data stored in the gain memory.

9. The electromagnetic strip stabilizer according to claim 4, further comprising:
a gain memory configured to store data of appropriate gains each corresponding to each of different combinations of the thickness, the width and the type of the steel strip, wherein the control section determines the control gains by referring to the data stored in the gain memory.

10. A method to control a vibration of a steel strip, the method comprising:
passing the steel strip between a pair of electromagnets facing each other after a surface coating process being applied to the steel strip;
detecting a distance between the electromagnets and the steel strip;
determining control gains to control a current to be supplied to each of the electromagnets based on a thickness and a width of the steel strip; and
supplying the current to each of the electromagnets and controlling the vibration of the steel strip based on the distance between the steel strip and each of the electromagnets detected in the sensing.

11. The method according to claim 10, wherein the determining determines the control gains further based on a type of the steel strip.

12. The method according to claim 11, further comprising:
storing data of appropriate gains each corresponding to each of different combinations of the thickness, the width and the type of the steel strip, wherein the determining determines the control gains by referring to the data stored in the storing.
